(19) United States
(12) Patent Application Publication
(10) Pub. No.: US 2014/0225432 A1
(43) Pub. Date: Aug. 14, 2014

(54) CONVERTER CIRCUIT AND METHOD FOR TRANSFERRING ELECTRICAL ENERGY

(71) Applicant: Hans Geyer, Leinfelden-Echterdingen (DE)

(72) Inventor: Hans Geyer, Leinfelden-Echterdingen (DE)

(73) Assignee: ROBERT BOSCH GMBH, Stuttgart (DE)

(21) Appl. No.: 14/241,124

(22) PCT Filed: Jun. 20, 2012
(86) PCT No.: PCT/EP2012/061840

§ 371 Date: Feb. 26, 2014

(30) Foreign Application Priority Data
Aug. 29, 2011 (DE) 10 2011 081 720.4

(51) Int. Cl. B60L 11/02; B60L 11/18

(52) U.S. Cl. CPC B60L 11/02; B60L 11/18
USPC 307/10.1

(57) ABSTRACT

The invention relates to a converter circuit (50) for transferring electrical energy, in particular for application in a motor vehicle wiring system (38, 42), which converter circuit comprises an electromagnetic transfer unit (60) having three electromagnetic transfer members (62, 64, 66) that can be electromagnetically coupled to each other in order to transfer electromagnetic energy, wherein the first electromagnetic transfer member (62) is connected to a first bi-directional converter circuit that comprises a first voltage connection pole pair (80) for connecting an AC voltage source and/or sink (54), wherein the second electromagnetic transfer member (64) is connected to a rectifier converter circuit that is connected on the outlet side to an electrical energy store (88), and wherein the third electromagnetic transfer member (66) is connected to a second bi-directional converter circuit that comprises a second voltage pole pair (96) for connecting a DC voltage source and/or sink (98), and a control unit (100) that is connected to the first bi-directional converter circuit, the second bi-directional converter circuit and the rectifier converter circuit, in order to control the exchange of electrical energy between the AC voltage source and/or sink (54), the DC voltage source and/or sink (98) and/or the electrical energy store (88).

### BACKGROUND OF THE INVENTION

The invention relates to a converter circuit for transferring electrical energy by means of an electromagnetic transfer unit.

The invention further relates to a method for transferring electrical energy by means of a converter circuit of the type mentioned above.

Finally the invention relates to an onboard voltage supply system of a motor vehicle comprising a converter circuit for transferring electrical energy of the type mentioned above.

It is commonly known in the field of motor vehicle drive technology to use an electrical machine as a drive and to supply said electrical machine comprising a high-voltage battery with electrical energy. As a result, the high voltage battery is usually assigned to a high-voltage onboard supply system which has a voltage of more than 120 volts. It is furthermore commonly known to provide a low-voltage onboard supply system having a DC voltage of 12 volts in which at least one low-voltage supply battery is provided in order to provide the low-voltage onboard supply system with electrical energy.

It is furthermore commonly known to supply the high-voltage and/or the low-voltage battery of a motor vehicle with electrical energy via a public power mains and to thereby charge the corresponding battery.

The American patent specification US 2007/0276556 A1 discloses a vehicle electrical system of an electrically driven motor vehicle, in which electrical system electrical energy is exchanged between a high-voltage onboard supply system and a low-voltage onboard supply system by means of a DC voltage converter.

The disadvantage with the known systems is that separate charging devices are assigned to each of the onboard voltage supply systems or, respectively, to each of the batteries and a flexible exchange of electrical energy between the onboard voltage supply systems and an external electrical energy source cannot be implemented or only implemented with an increased amount of technical complexity.

### SUMMARY OF THE INVENTION

The present invention therefore provides a converter circuit for transferring electrical energy, in particular for application in a motor vehicle wiring system, which converter system comprises an electromagnetic transfer unit having at least three electromagnetic transfer members that can be electromagnetically coupled to each other in order to transfer electromagnetic energy, wherein the first electromagnetic transfer member is connected to a first bi-directional converter circuit that comprises a first voltage connection pole pair for connecting an AC voltage source and/or sink, wherein the second electromagnetic transfer member is connected to a rectifier converter circuit that is connected on the outlet side to an electrical energy store, and wherein the third electromagnetic transfer member is connected to a second bi-directional converter circuit that comprises a second voltage pole pair for connecting a DC voltage source and/or sink. Said converter system furthermore comprises a control unit that is connected to the first bi-directional converter circuit, the second bi-directional converter circuit and the rectifier converter circuit, in order to control the exchange of electrical energy between the AC voltage source and/or sink, the DC voltage source and/or sink and/or the electrical energy store.

According to the invention, a method for transferring electrical energy by means of a converter circuit of the type mentioned above is therefore furthermore provided, wherein the electrical energy is exchanged between the AC voltage source and/or sink, the DC voltage source and/or sink and/or the electrical energy store.

Finally, the present invention provides a vehicle onboard voltage supply system comprising a converter circuit of the type mentioned above.

By means of the common electromagnetic transfer unit, certain components can be commonly used and separate complicated converter units can be spared, whereby the technical complexity, costs and weight of the motor vehicle can be reduced. In addition, different energy flow directions can be adjusted by means of the control of the different components, whereby the exchange of electrical energy within the motor vehicle and with an external voltage source can be flexibly implemented.

In is particularly advantageous if the first bi-directional converter circuit comprises an electronic H-bridge circuit or, respectively, a four-quadrant converter, an inverter and a rectifier, wherein the system can be switched between the inverter and the rectifier depending on the power flow direction.

The electromagnetic transfer unit can thereby be connected to an external AC voltage source and/or sink; and electrical energy can be transferred from the external source to the electromagnetic transfer unit; and electrical energy can be transferred from the electromagnetic transfer unit to the external energy source.

In so doing, it is particularly advantageous if the rectifier is connected to a reactive power compensation circuit.

As a result, the reactive power removed from the AC voltage source and/or sink can be reduced. This results from the fact that the entire converter circuit thereby acts as an ohmic load.

It is further particularly advantageous if the second bi-directional converter circuit comprises an H-bridge circuit or a four-quadrant converter and a DC converter.

As a result, an AC voltage can bi-directionally be converted into a DC voltage using simple means, and the DC voltage that is converted in this manner can be matched to the voltage of the connected onboard voltage supply system.

It is furthermore preferred if the electromagnetic transfer unit is designed as a power transformer and the electromagnetic transfer members are designed as coils.

In so doing, electrical energy can be transferred in any direction from one of the transfer members to one or two of the other transfer members.

It is further generally preferred that the converter circuit is designed to transfer power from the AC voltage source and/or sink or from the DC voltage source and/or sink to the two respective other components connected to the electromagnetic transfer unit or to one of the two other components.

As a result, electrical energy can be transferred from any desired component to one or two other components according to demand and availability, whereby the flexibility of the entire converter circuit is generally increased.

It is further preferred if the first voltage pole pair is connected to a high-voltage battery and the electrical energy store is a low-voltage battery.

As a result, electrical energy can be exchanged by means of the converter circuit between the high-voltage battery of the high-voltage onboard supply system and the low-voltage battery of the low-voltage onboard supply system using simple means.

It is further preferred if the first voltage pole pair is connected to a multi-phase inverter in order to provide a multi-phase AC voltage.

In so doing, multi-phase consumers, as, e.g., three-phase machines, can be provided with electrical energy from the converter circuit. In addition, high partial load efficiencies can be achieved.

It is furthermore preferred if the first bi-directional converter circuit and/or the second bi-directional converter circuit are designed as a resonant converter.

The efficiency of the corresponding converter circuits can thereby be increased.

In addition, it is particularly preferred in a vehicle onboard voltage supply system according to the present invention if the control unit is connected to the converters via a vehicle wiring system.

In so doing, the amount of wiring can be reduced using appropriate control cables and the actuated components of the converter circuit can be installed at arbitrary positions in the motor vehicle without increasing the amount of wiring.

It goes without saying that the features, properties and advantages of the inventive converter circuit also correspondingly apply to or are true for the method according to the invention.

### BRIEF DESCRIPTION OF THE DRAWINGS

FIG. 1 shows in schematic form a motor vehicle comprising a hybrid drive train and a high-voltage onboard supply system and a low-voltage onboard supply system;

FIG. 2 shows in schematic form a converter circuit for exchanging electrical energy between an external voltage source and/or sink and the high-voltage onboard supply system and the low-voltage onboard supply system of the motor vehicle.

### DETAILED DESCRIPTION

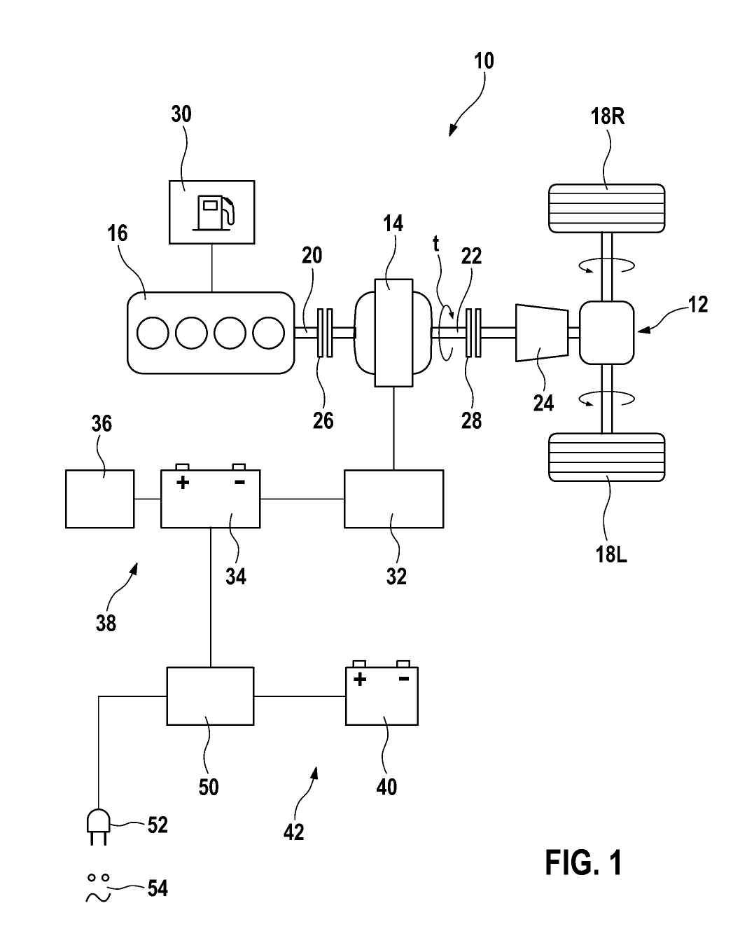

In FIG. 1, a motor vehicle is schematically depicted and denoted in total by the reference numeral 10. The motor vehicle 10 comprises a drive train 12 which, in the present case, includes an electrical machine 14 and an internal combustion engine 16 for providing driving power. The drive train 12 serves to propel the driven wheels 18 L, 18 R of the motor vehicle 10.

The internal combustion engine 16 is connected or can be connected via a crankshaft 20 to the electrical machine 14, wherein said internal combustion engine 16 and the electrical machine 14 provide a torque t at a driven shaft 22 which rotates at an adjustable rotational speed. The driven shaft 22 is connected or can be connected to a transmission unit 24 in order to transmit the torque t to the driven wheels 18R, 18L. The crankshaft 20 and the driven shaft 22 comprise in each case a clutch 26, 28 in the present case in order to connect the combustion engine 16 to the electrical machine 14 or the electrical machine 14 to the transmission unit 24.

The drive train 12 can be equipped to drive the vehicle 10 solely by means of the electrical machine 16 (electric vehicle). The electrical machine 16 can alternatively be part of a hybrid drive train 12 as in the present case.

The crankshaft 20 is connected or can be connected by means of the clutch 26 to a rotor of the electrical machine 14 in order to transmit a rotational speed or a torque to the electrical machine 14. The rotor of the electrical machine 14 is connected to the driven shaft 22 in order to transmit the torque t to the transmission unit 24. The torque t is thereby formed from the sum of the individual torques provided by the internal combustion engine 16 and the electrical machine 14.

When the electrical machine is being used as a motor, the electrical machine 14 generates a drive torque which assists the internal combustion engine 16, for example in an acceleration phase. In the generator operating mode or recuperation operation, the electrical machine 14 generates electrical energy which is commonly made available to the motor vehicle 10.

The internal combustion engine 16 is supplied with fuel by means of a fuel tank 30.

The electrical machine 14 can be of single- or multi-phase design and is actuated by means of power electronics 32 or an inverter and is supplied with electrical energy. The power electronics 32 are connected to an energy supply unit 34 such as a DC voltage supply (e.g. accumulator or battery) 34 of the vehicle and serve to convert an voltage supplied by the energy supply unit 34 into alternating current in general or into a number of phase currents for the phases of the electrical machine 14. The energy supply unit 34 is connected to a battery control device 36 which is designed to control the energy supply of the electrical machine 14 via the power electronics 32 and the charging state of the energy supply unit 34. The power electronics 32 are further designed to charge the energy supply unit 34 by means of the electrical energy generated by the electrical machine 14 during the recuperation operation of the electrical machine 14.

The energy supply unit 34, the power electronics 32 and the battery control device 36 are part of a high-voltage onboard supply system 38 of the motor vehicle 10.

The motor vehicle 10 further comprises a low-voltage supply unit 40 (e.g. a battery) which supplies a low-voltage onboard supply system 42 of the motor vehicle 10 with a corresponding voltage. The high-voltage onboard supply system 38 is connected by means of a converter 50 to the low-voltage onboard supply system 42 in order to exchange electrical energy between the two onboard voltage supply systems 38, 42.

The converter 50 can furthermore be connected by means of a connection unit 52 to an external energy source and/or sink 54. Said external energy source and/or sink is preferably a public AC voltage mains 54 which can transmit electrical energy via a converter 50 into the onboard voltage supply systems 38, 42 and into which electrical energy can be transmitted from the onboard voltage supply systems 38, 42. In so doing, surplus energy can be discharged from the motor vehicle 10 or the energy supply units 34, 40 can be charged via the electrical energy source and/or sink.

As a result, electrical energy can therefore arbitrarily be exchanged between the three energy networks 38, 40, 54.

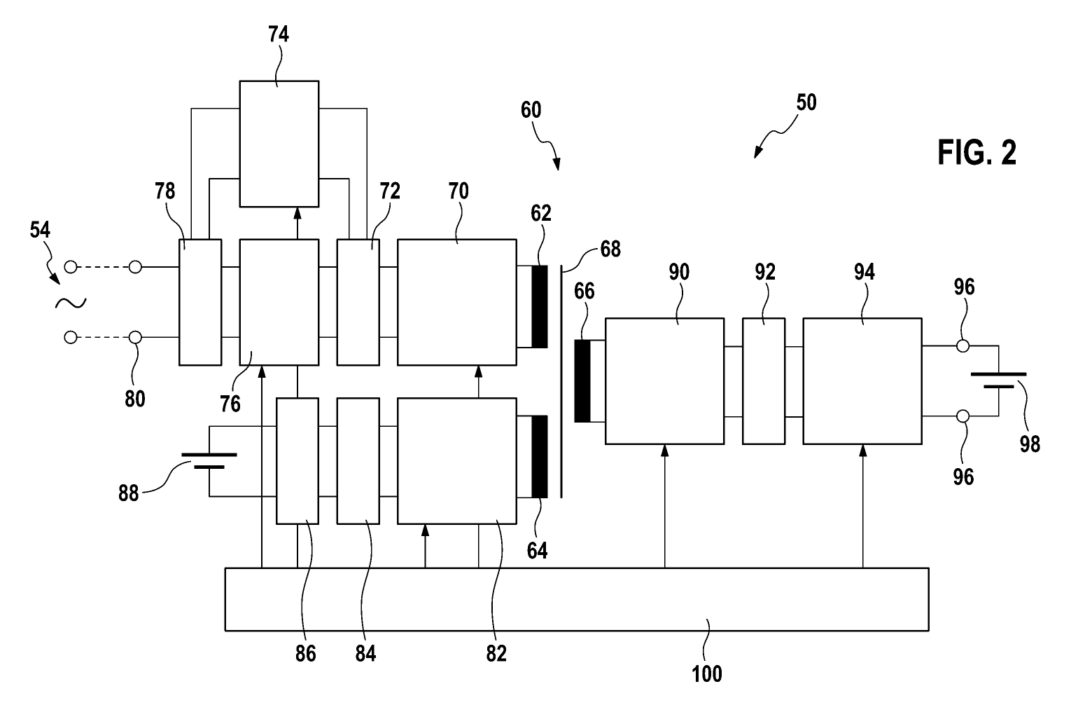

FIG. 2 shows an embodiment of the converter 50 for transferring electrical energy in schematic form.

The converter 50 comprises an electromagnetic transfer unit 60 having three electromagnetic transfer members 62, 64, 66. The electromagnetic transfer members 62, 64, 66 are each formed by a coil 62, 64, 66 and are electromagnetically coupled to each other, preferably via an iron core 68.

The first coil 62 is connected to an electronic H-bridge circuit 70 which can also be configured as a four-quadrant converter 70. The H-bridge circuit 70 converts a DC voltage into an AC voltage and is designed to transfer electrical energy in both directions. Thus, the H-bridge circuit of the first coil 62 provides an AC voltage and can convert an AC voltage from the coil 62 into a DC voltage. The H-bridge circuit 70 is connected to an intermediate circuit capacitor 72 and provides the DC voltage to the same. The intermediate circuit capacitor can be connected to an inverter 74 and to a reactive power compensation circuit 76, wherein the intermediate circuit capacitor 72 is connected to the inverter 74 or the reverse power compensation circuit 76 depending on the transfer direction of the electrical energy. The reverse power compensation circuit 76 is further connected via a rectifier 78 to an AC voltage pole pair 80. The rectifier 74 is or can be likewise connected to the AC voltage pole pair 80.

The AC voltage pole pair 80 corresponds in principle to the connection unit 52 and can be connected to an external voltage source and/or sink which preferably is formed by the public AC voltage mains 54.

Provided that electrical energy is to be transferred from the public mains 54 to the converter 50 or to the components connected thereto, the AC voltage is converted at the AC voltage terminals 80 by means of the rectifier 78 into a DC voltage. By means of the reactive power compensation circuit, the entire converter 50 acts like an ohmic load and the consumption of reactive power can be prevented by said reactive power compensation circuit 76. In this case, the reactive power compensation circuit 76 is connected via the intermediate circuit capacitor 72 to the H-bridge circuit 70 in order to convert the DC voltage into AC voltage which is transferred to the first coil 62. In this way, electrical energy can be transferred from the public AC voltage mains 54 to the converter 50 or the electromagnetic transfer unit 60.

Provided electrical energy is to be transferred from the electromagnetic transfer unit 60 to the public mains 54, the intermediate circuit capacitor 72 is decoupled from the reactive power compensation circuit 76 and connected to the rectifier 74. The rectifier is connected to the AC voltage pole pair 80. In this case, the H-bridge circuit 70 converts the AC voltage, which is provided by the first coil 62, into a DC voltage, wherein the DC voltage is converted by the inverter 74 into an AC voltage and transmitted to the AC voltage pole pair 80. In this way, electrical energy can both be coupled and decoupled.

The second electromagnetic transfer member 64 is designed as a coil 64 and is connected to an inverter 82 that is connected on the outlet side via an intermediate circuit capacitor 84 and a filter 86 to an electrical energy store 88. The rectifier 82 converts the AC voltage supplied by the coil 64 into a DC voltage and transfers the DC voltage via the intermediate circuit capacitor 84 and the filter 86 to the electrical energy store 88 in order to correspondingly charge the same. The energy store 88 is preferably designed as a low-voltage battery and substantially corresponds to the low-voltage supply unit 40 from FIG. 1. Due to the nature of the system, electrical energy can only be transferred from the second coil 64 to the electrical energy store 88, but not in the opposite direction. In an alternative embodiment, the rectifier 82 is designed as an H-bridge circuit or four-quadrant converter; thus enabling electrical energy to be transferred from the energy store 88 to the electromagnetic transfer unit 60 and therefore to the other components.

The third electromagnetic transfer member 66 is designed as a third coil 66 and is connected to a second electronic H-bridge circuit 90 which can also be designed as a four-quadrant converter 90. The H-bridge circuit 90 is connected on the outlet side via an intermediate circuit capacitor 92 to a DC voltage converter 94. The DC voltage converter 94 is connected to a DC voltage pole pair 96. An electrical energy store 98 is connected to the DC voltage pole pair 96, said electrical energy store being preferably designed as a high-voltage battery 98. Corresponding power electronics, such as, e.g. the power electronics 32, the electrical machine 14, can furthermore be connected via a corresponding rectifier to the DC voltage pole pair 96. By means of the H-bridge circuit 90 and the DC voltage converter 94, electrical energy can be transferred from the DC voltage pole pair 96 to the third coil 66 and can be transferred in the opposite direction from the third coil 66 to the DC voltage pole pair 96. As a result, electrical energy can be transferred from the high-voltage battery 98 or the electrical machine 14 connected thereto to the electromagnetic transfer unit 60 and the components connected thereto. Electrical energy can also be transferred from the electromagnetic transfer unit 60 to the DC voltage pole pair 96 and the high-voltage battery 98 or the electrical machine 14 connected thereto.

The converter 50 further comprises a control unit 100 which is connected to the inverter 74, the reactive power compensation circuit 76, the H-bridge circuit 70, the filter 86, the rectifier 82, the H-bridge circuit 90 and the DC voltage converter 94. The control unit 100 is therefore capable of controlling all of the components of the converter 50 in order to correspondingly exchange electrical energy arbitrarily between the components. In particular, electrical energy from the public mains or the external AC voltage source and/or sink 54 is transferred in a first setting to the high-voltage battery 98 in order to correspondingly charge the same. Electrical energy from the high-voltage battery 98 is furthermore transferred in a second setting to the low-voltage battery 88 in order to charge the same. Furthermore, electrical energy from the external AC voltage source 54 and/or sink is transferred in a third setting to the high-voltage battery 98 as well as to the low-voltage battery 88 in order to charge said energy stores. Electrical energy from the high-voltage battery 98 or the electrical machine 14 is furthermore transferred in a fourth setting to the low-voltage battery 88 as well as being transferred to or fed into the public mains 54. In addition, electrical energy from the high-voltage battery 98 is transferred in a fifth setting to the public mains 54 or is fed into said public mains 54.

Electrical energy can thus be exchanged arbitrarily between the individual components by means of the converter 50.

The converter circuit 10 according to the invention is fundamentally not limited to three electromagnetic transfer members 62, 64, 66. In one embodiment, the electromagnetic transfer unit 60 can also comprise more transfer members 62, 64, 66 which are connected to corresponding converter circuits in order to receive energy from the transfer unit 60 or supply energy to said transfer unit.

By connecting corresponding adapter modules to the electromagnetic transfer unit 60 or to the corresponding voltage pole pairs 80, 96, the converter can alternatively be coupled to any desired DC voltage and/or AC voltage sources, such as solar energy systems, fuel cells, quick charge charging units or something similar without the use of multistage inverters or intermediate converters which involve a degree of energy loss. By appropriately designing the converter 50, the AC voltage pole pair 80 can be connected to any voltage networks in the world.

In addition, the overall principle can also be applied to multilevel converters in order to achieve a high degree of partial load efficiency. The control complexity for the control unit 100 would have to be correspondingly adapted. In principle, the coils 62, 64, 66 can also be connected to a resonant converter in order to correspondingly increase the degree of efficiency.

The control unit 100 is connected to the corresponding components preferably via a vehicle communication network (LEN, CAN, FlexRay or something similar).

Correspondingly efficient microcontrollers for system controlling and simultaneous implementation of online control tasks can be used so that the overall control can be constituted with low hardware outlay. Measures which are typical of motor vehicles with respect to reliability as well as to reset and restart are likewise to be provided on the control unit side. The supply of current to the control unit takes place via the onboard voltage supply system; and the galvanically decoupled actuation of the individual semiconductor switches takes place via commercially available insulating gate drivers.

The sum of the partial power flows through the converter 70, 82, 90 or the coils 62, 64, 66 connected thereto is always less than a predefined value, which is determined by the system design. Thus, the sum of the power flows is always less than a predefined maximum value.

1. A converter circuit for transferring electrical energy, in particular for application in a motor vehicle wiring system, which converter circuit comprises an electromagnetic transfer unit having at least three electromagnetic transfer members that can be electromagnetically coupled to each other in order to transfer electromagnetic energy, wherein the first electromagnetic transfer member is connected to a first bi-directional converter circuit that comprises a first voltage connection pole pair for connecting an AC voltage source and/or sink, wherein the second electromagnetic transfer member is connected to a rectifier converter circuit that is connected on the outlet side to an electrical energy store, and wherein the third electromagnetic transfer member is connected to a second bi-directional converter circuit that comprises a second voltage pole pair for connecting a DC voltage source and/or sink, and a control unit that is connected to the first bi-directional converter circuit, the second bi-directional converter circuit and the rectifier converter circuit, in order to control the exchange of electrical energy between the AC voltage source and/or sink, the DC voltage source and/or sink and/or the electrical energy store.

2. The converter circuit according to claim 1, wherein the first bi-directional converter circuit comprises an electronic H-bridge circuit or a four-quadrant converter, an inverter and a rectifier, wherein the system can be switched between the inverter and the rectifier depending on the power flow direction.

3. The converter circuit according to claim 2, wherein the rectifier is connected to a reactive power compensation circuit.

4. The converter circuit according to claim 1, wherein the second bi-directional converter circuit comprises an electronic H-bridge circuit or a four-quadrant converter and a DC voltage converter.

5. The converter circuit according to claim 1, wherein the electromagnetic transfer unit is designed as a transformer and the electromagnetic transfer members are designed as coils.

6. The converter circuit according to claim 1, wherein the converter circuit is designed to transfer electrical power from the AC voltage source and/or sink or from the DC voltage source and/or sink to the two respective other components connected to the electromagnetic transfer unit or to one of the two other components.

7. The converter circuit according to claim 1, wherein the second voltage pole pair is connected to a high-voltage battery and wherein the electrical energy store is a low-voltage battery.

8. The converter circuit according to claim 1, wherein the second voltage pole pair is connected to a multi-phase inverter in order to provide a multi-phase AC voltage.

9. Converter circuit according to claim 1, wherein the first bi-directional converter circuit and/or the second bi-directional converter circuit are designed as resonant converters.

10. A method for transferring electrical energy by means of a converter circuit according to claim 1, wherein the electrical energy is exchanged between the AC voltage source and/or sink, the DC voltage source and/or sink and/or the electrical energy store.

11. An onboard voltage supply system of a motor vehicle comprising a converter circuit according to claim 1.

12. The onboard voltage supply system of a motor vehicle according to claim 11, wherein the control unit is connected via a motor vehicle wiring system to the converter circuits.
